(19) United States
(12) Patent Application Publication
(10) Pub. No.: US 2007/0254151 A1
(43) Pub. Date: Nov. 1, 2007

(54) System for concealing joints

(76) Inventor: Michael C. Colucci, Hillsborough, NJ (US)

Correspondence Address: NATIONAL STARCH AND CHEMICAL COMPANY, P.O. BOX 6500, BRIDGEWATER, NJ, 08807-3300, US

(21) Appl. No.: 11/414,992

(22) Filed: May 1, 2006

(51) Int. Cl. B32B 7/12

(52) U.S. Cl. 428/355 EP

(57) ABSTRACT

Materials and methods are provided to quickly and conveniently conceal drywall seams, corner joints and nail and screw holes or other imperfections in drywall material. Joints are concealed in a single application procedure to produce at least a Level 3 equivalent wall surface preparation.

### FIELD OF THE INVENTION

The invention relates to a composite structure that may be used to conceal the joint between adjacent sheets of dry wall or may be used in various other types of sealing operations.

### BACKGROUND OF THE INVENTION

Wallboard sheets are widely used in building construction to form, e.g., the walls and ceilings of rooms and the like. Drywall construction involves applying a plurality of wallboard panels to framing (using screw or nail fasteners) and then concealing the joint or seam between the adjacent board panels. A common method of concealing these joints consists of adhering a narrow paper joint tape over the joint region using an aqueous joint compound, also variously referred to in the art as a cementitious adhesive, drywall mud or spackle. The paper tape provides reinforcing strength to the joint system, preventing cracking of the joint compound along the joint line.

After the joint compound has been allowed to dry for a period of, typically, about one day, a thin layer of the joint compound is applied over the adhered tape, this layer being somewhat wider than the paper tape and which layer is tapered out to very thin edges. This second layer of joint compound is allowed to dry, again typically, for about one day and yet another thin layer of joint compound, somewhat wider than the prior coat, is applied thereover. Typically, the layers are sanded or otherwise smoothed between coatings. In this manner a final substantially monolithic wall surface appearance is provided when the surface is covered with a coating of paint, wall paper or other decorative wall covering.

While this process is generally the way walls and ceilings are constructed, the practice is time consuming (on the order of days) and requires substantial clean-up, both in terms of sweeping- or vacuuming-up the accumulated dust resulting from each sanding and washing the required speckling knifes and mud buckets. This method also requires protective gear, e.g., dust mask, to prevent inhalation of dust particles during sanding operations and clean-up.

U.S. Pat. Nos. 3,576,091 and 3,842,551 disclose that joints can be covered by (1) spreading a fluid layer of a hot melt adhesive over the joint region using a modified heat gun or, alternatively, (2) heating a joint reinforcing tape comprising a hot melt adhesive to an elevated temperature so that the adhesive becomes tacky, and then placing the tape over the joint and cooling the strip of tape. These methods of covering dry wall joints are described by the patentees as eliminating the necessity of waiting about one day after the initial layer of adhesive has been laid down before the next layer can be applied as has heretofore been the case. I.e., a hot melt adhesive is used in place of the initial layer of cementitious adhesive. Using the process of this prior art invention, following application of the hot melt adhesive, either alone or using a reinforcing material carrier, it is not necessary to observe a waiting period before applying at concealing layers of an aqueous cementitious adhesive to prepare the joint for final finishing (e.g., painting).

There continues to be a need in the art for novel materials and methods that can be used to substantially reduce the amount of time it takes to prepare wall board for final finishing, e.g., painting or the like, reduces the associated mess, and also reduces the costs, in particular labor and clean-up costs. The current invention fulfils this need.

### SUMMARY OF THE INVENTION

The invention provides materials and methods used to conceal drywall seams (also referred to herein as flat joints or, merely, joints), corner joints and fastener (nail and screw) heads, or other imperfections in drywall material.

The present invention provides materials and methods that can be used to quickly and conveniently prepare wall surfaces equivalent to at least a Level 3 finish, more preferably to a Level 4 finish equivalency, by concealing joints, fastener heads and the like in a single application step and without the need to dispose there over an additional layer or layers of aqueous cementitious adhesive.

One embodiment of the invention provides an article that can be used to conceal a joint formed between wall board panels when such panels are erected in edge abutting relationship during the manufacture of simulated monolithic walls and ceilings.

In one preferred aspect of this embodiment the article comprises a reinforcing material having a front side and a back side and a predetermined length, width and thickness. A first adhesive is present on at least a portion of the front side of the reinforcing material and a second adhesive is present on at least a portion of said back side of the reinforcing material. A heat resistant release liner having a front side and a back side and a predetermined length, width and thickness, is positioned such that the first adhesive is located between the front side of said reinforcing material and said back side of said release liner. At least one of the first or second adhesive extends beyond at least the width of the reinforcing material.

In another preferred aspect of this embodiment, the article comprises a reinforcing material having a front side and a back side and a predetermined length, width and thickness, and at least a first adhesive layer present on at least a portion of the front side or the back side. A heat resistant release liner having a front side and a back side and a predetermined length, width and thickness, is positioned such that the front side of the reinforcing material faces the back side of the release liner. At least the first adhesive extends beyond at least the width of the reinforcing material.

Encompassed by the invention are articles in which the first and second adhesive layers are the same or different. Preferably, at least the one of the first or second adhesive layers is a thermoplastic adhesive. Hot melt adhesives may advantageously be used in the practice of the invention.

In a particularly preferred embodiment, the article comprises a reinforcing material having a width of about 2 inches, an adhesive layer having a width of about 4 inches, and a release liner having a width of about 6 inches, wherein the adhesive is sandwiched between the reinforcing material and the release liner.

Another embodiment of the invention provides a method of concealing a dry wall joint comprising positioning the article described herein over a formed joint, the article being positioned so that the back side of the reinforcing material faces the joint surface. Pressure and sufficient heat is then applied to the front side of the release liner to cause at least the adhesive to flow and bond to the dry wall, whereby the joint is concealed. Using the method of the invention, the article bonds to the drywall and conceals the joint to provide at least a level 3 equivalent finish.

In yet another embodiment of the invention, a simulated monolithic wall is prepared by a process in which wall board panels are erected in edge abutting relationship whereby a joint is formed there between. The joint is then covered by positioning the article over the formed joint such that the back side of the reinforcing material faces the joint surface, and pressure and sufficient heat is then applied to said front side of the release liner to cause the adhesive to flow, bond to the dry wall and conceal the joint. The joint is concealed in a single application step to provide at least a level 3 equivalent finish, and then a final wall covering finish (e.g., wall paper, paint) is applied.

Also provided by the invention are methods and articles for concealing fastener heads. The article comprises a heat resistant release liner having positioned thereon a substantially circular deposit of a thermoplastic adhesive, said deposit having a mean diameter of at least about an inch, and which deposit is substantially thicker in the middle than at its circumference, at which circumference the deposit is very thin compared to the center of the deposit.

### BRIEF DESCRIPTION OF THE DRAWINGS

FIG. 1 is a perspective view of a composite structure (article) comprising a reinforcing material embedded in an adhesive material and which is coated onto a release liner.

FIG. 2 shows an exploded cross-section profile of the composite structure shown in FIG. 1.

FIG. 3 shows an enlarged profile of the adhesive layer of FIG. 1.

FIG. 4 shows the release liner of FIG. 1

FIGS. 5 and 6 show cross-sectional profiles of two additional embodiments of the composite article of the invention.

FIG. 7 is a diagram illustrating a method of making the composite structure of the invention.

FIGS. 8 and 9 are cross-sectional views of a heating apparatus that can be used to apply the articles of the invention to wall board.

### DETAILED DESCRIPTION OF THE INVENTION

Wallboard sheets generally comprise a gypsum core with outer face layers of paper, and are typically referred to as gypsum board, sheet rock or drywall. Gypsum wallboard is typically manufactured by delivering a slurry or paste containing crushed gypsum rock onto a moving sheet of facing paper to which a second or top paper layer is then added to form a long board line. The board line permits the slurry to harden before being cut. The cut panels are heated in a kiln, before being packaged for storage and shipping. Typically, such sheets are ½ or ⅝ inch thick and in conventional sizes of 4×8 feet, and may weigh from about 55 to about 70 pounds.

The use of aerated concrete as the core material in wallboard sheeting is also known. See, e.g., published International patent WO 00/27866, which describes a wallboard sheet comprising an aerated concrete core covered with outer face layers. Aerated concrete is a steam cured mixture of sand or pulverized fuel ash, cement, lime and an aeration agent. High pressure steam curing in an autoclave produces a physically and chemically stable product with an average density being about one fifth that of normal concrete. The material includes non connecting air cells, and this gives aerated concrete some of it its unique and advantageous properties such as good strength, low weight (a 1 inch thick, 4 foot by 8 foot wallboard sheet typically has a total weight of about 60 pounds), good thermal insulation properties, good sound deadening properties, and has a high resistance to fire.

Both conventional sheet rock and aerated concrete sheets are typically manufactured to have beveled portions adjacent respective opposing side edges, may be readily cut to size by first scoring the face sheet, and then snapping the board about the score line, and may be easily fastened to a suitable building frame.

Whether using conventional gypsum board or other type of wall board, the seams between adjacent wallboards must be covered (i.e., taped and spackled) to provide an even wall surface, and then painted or, alternatively, covered with a decorative wall covering. Taping and spackling is extremely time consuming, typically requiring 2, or 3, or more days to obtain an even wall surface suitable for painting or other final finishing.

The extent of wall surface preparation, also referred to as gypsum board finish, is typically described in terms of levels of finish. For example, walls erected in warehouses and other areas where appearance is not critical may require a low level of finish, e.g., just taping and spackling of fastener heads. On the other hand, blemish-free, smooth, monolithic walls and ceilings in homes will require additional finishing prior to application of final decoration. By designating a desired level of finish, the contractor can consider the correct labor and materials required when bidding for a job, and will know how to finish the wall suitable for its desired final decoration. Levels of wall board finish are incorporated into ASTM C 840, “The Standard Specification for Application and Finishing of Gypsum Board.” The following levels are used in the art and herein to describe surface finishes.

Level 0—no taping, finishing or accessories (e.g., metal corner bead) required.

Level 1—All joints and interior angles shall have tape set in joint compound. Surface shall be free of excess joint compound. Tool marks and ridges are acceptable.

Level 2—All joints and interior angles shall have tape embedded in joint compound and wiped with a joint knife leaving a thin coating of joint compound over all joint and interior angels. Fastener heads and accessories shall be covered with a coat of joint compound. Surface shall be free of excess joint compound. Tool marks and ridges are acceptable.

Level 3—All joints and interior angles shall have tape embedded in joint compound and one additional coat of joint compound applied over all joints and interior angles. Fastener heads and accessories shall be covered with two separate coats of joint compound. All joint compound shall be smooth and free of tool marks and ridges.

Level 4—All joints and interior angles shall have tape embedded in joint compound and two separate coats of joint compound applied over all flat joints and one separate coat of joint compound applied over interior angles. Fastener heads and accessories shall be covered with three separate coats of joint compound. All joint compound shall be smooth and free tool marks and ridges.

Level 5—All joints and interior angles shall have tape embedded in joint compound and two separate coats of joint compound applied over all flat joints and one separate coat of joint compound applied over interior angles. Fastener heads and accessories shall be covered with three separate coats of joint compound. A thin skim coat of joint compound shall be applied to the entire surface. The surface shall be smooth and free tool marks and ridges.

The present invention provides materials and methods that can be used to quickly and conveniently prepare wall surfaces equivalent to at least a Level 3 or better. Level 3 is typically specified in appearance areas which are to receive heavy- or medium-texture finishes before final painting, or where heavy-grade wall coverings are to be applied as the final decoration. Level 4 is typically designated where flat paints, light textures or wall coverings are to be applied.

The invention provides a system that can be used not only to cover, but to conceal drywall seams, corner joints, fastener heads (nail and screw heads) or other imperfections in drywall material in a single step. The system of the invention eliminates the need for drying time and also eliminates the need for sanding or compounding prior to painting or hanging of a wall covering/wall paper. Use of the system of the invention dramatically reduces (i.e., from a period of days to a period of hours) the time from start to finish.

The invention provides a heat activatable composite, also referred to herein as an article, that is used to bond together sheets of drywall and conceal the joint there between. The article of the invention, and components thereof (reinforcing substrate, adhesive layers, release liner) have a predetermined width, length and thickness.

By “predetermined” width, length and thickness means that the article can be manufactured in various dimensions as required or desired for, e.g., performance, manufacture, marketing, end uses, etc. Use of the term “predetermined” profile or “predetermined” interval is likewise used to mean that the profile or interval is chosen as required or desired.

The composite comprises a paper strip or other reinforcing substrate having a front side and a back side, an adhesive present on at least a portion of said front side or back side, and a heat resistant release liner having a front side and a back side.

Front side is used herein to refer to the surface of the article or component thereof facing the interior of the room when the article is placed in parallel juxtaposition to the wall or ceiling surface.

Back side is used herein to refer to the surface of the article or component thereof facing the wall or ceiling of the room when the article is placed in parallel juxtaposition to the wall or ceiling surface.

Examples of reinforcing materials include paper tapes and perforated fiber tapes, such as fiberglass mesh. In a preferred embodiment a first adhesive is present on at least a portion of the front side of the reinforcing material and a second adhesive is present on at least a portion of the back side of the reinforcing material. The first and second adhesive may be the same or different. In one preferred embodiment, at least the first adhesive is a hot melt adhesive and the second adhesive exhibits pressure sensitive properties. The heat resistant release liner has a front side and a back side and a predetermined length and width. The release liner is positioned such that the first adhesive is located between the front side of the reinforcing material and the back side of the release liner. In one preferred embodiment, the second adhesive is contained within the boundaries of the reinforcing material, and the first adhesive extends beyond the width of the reinforcing material but is contained within the boundaries of the release liner.

The invention also provides a method of concealing a dry wall joint comprising positioning the herein described article of the invention over a formed joint. The article is positioned so the back side of the reinforcing material faces the joint surface. Sufficient pressure and heat is applied to front side of the release liner to cause at least the first adhesive to flow, bond to the dry wall and conceal the joint.

It is a further object of the invention to provide a simulated monolithic wall comprising wall board panels erected in edge abutting relationship whereby a joint is formed there between, and then concealing the joints by this method of the invention. Simulated monolithic wall can be prepared by erecting wall board panels in edge abutting relationship whereby a joint is formed there between, concealing the joint by positioning the article of the invention over a formed joint, said article positioned so the back side of the reinforcing material faces the joint surface, applying pressure and sufficient heat to said front side of the release liner to cause at least said first adhesive to flow, bond to the dry wall and conceal the joint, and applying a wall covering finish such as, for example, flat paint.

The present invention provides heat activatable films. One preferred heat activatable film comprises a thermoplastic adhesive material. The heat activatable film may comprise at least two adhesive layers. The adhesive layers may be the same or different. The adhesives may be the same or different types of adhesives. While the adhesives may be the same in type (e.g., hot melt adhesives), the adhesives may or may not share the same formulation or the same properties.

Preferably, at least one of the layers is a hot melt adhesive. In one embodiment both adhesive layers are hot melt adhesives. In one preferred embodiment, the adhesive has embedded therein a reinforcing material.

The heat activatable film of the invention are conveniently used to form joint systems between adjacent wallboard panels.

The heat activatable material may comprise a hot melt adhesive applied to a release liner. In one embodiment the hot melt adhesive may be sandwiched between two release liners. A release liner may be applied to both surfaces, but more typically will be applied only to one surface, becoming sandwiched therebetween upon rolling for storage and packaging.

In a preferred embodiment of the invention, the heat activatable film comprises a reinforcing material having predetermined boundaries, said material being sandwiched between first and second adhesive layers, at least one of said adhesive layers being a hot melt adhesive. The reinforcing material has a predetermined length and width. The adhesive may be contained within the boundaries of the reinforcing material, but at least one adhesive layer will typically extend beyond at least the width. In one embodiment both the first and second adhesive layer extends beyond the width of the reinforcing material and embeds the reinforcing material therebetween. At least one of said first or second adhesive layer will also typically, and preferably, have a predetermined specific profile, e.g., a profile of peaks and valleys.

For use in the practice of several aspects of this invention, the width will typically range from about 2 inches to about 6 inches or more. Films comprising a reinforcing material may be manufactured in any desired or convenient length. Rolls containing 20 to 50 yards or more can be conveniently manufactured. The films can also be manufactures in varying lengths such as 2, four six eight feet or the like.

In one embodiment, lengths of heat activatable films designed for application to an outer corner, or an inner corner, or any desired angle, e.g., 90°, 45°, inside or outside angle, can be manufactured in a desired length.

The invention also comprises composites comprising a release liner containing, a predetermined intervals, dollops of adhesive that can be used to fill nail and screw holes or other imperfections in drywall material.

The reinforcing material, also called “tape” embedded within or adhered to the adhesive may be a material such as paper, or may be made of other material such as, but not limited to nylon mesh, plastic, metal, coated paper, foil, vinyl, or cardboard. Such materials may be similar to commercially available materials used in the joint taping application today, such as are “Wall Span®”, “Sheet Rock® Joint Tape” or “Easy Joint Tape”.

A preferred embodiment of the invention is directed to a composite of adhesive plus a reinforcing substrate. The composite of the invention will typically and more preferably have a profile that is thinner (approaching 0.001 inch) on the edges of the profile and thicker (approaching 0.070 inch) in the center, and be preferably about 3 to 8 inches wide. The composite is coated on a liner, such release liner or other material, that is wider than the composite; and is preferably about 6 to 10 inches wide. The side of the construct that is the application side, i.e., the side that will come in contact with the wall board, will preferable be an adhesive that demonstrates residual tack that will allow the composite to be temporarily positioned on the wall board. The composite will be positioned or otherwise placed on the wall board over the joint created by the adjoining pieces of wall board by cutting the given length or lengths to fit the joint thereby fully concealing it when it is pressing with the addition of heat through the release liner.

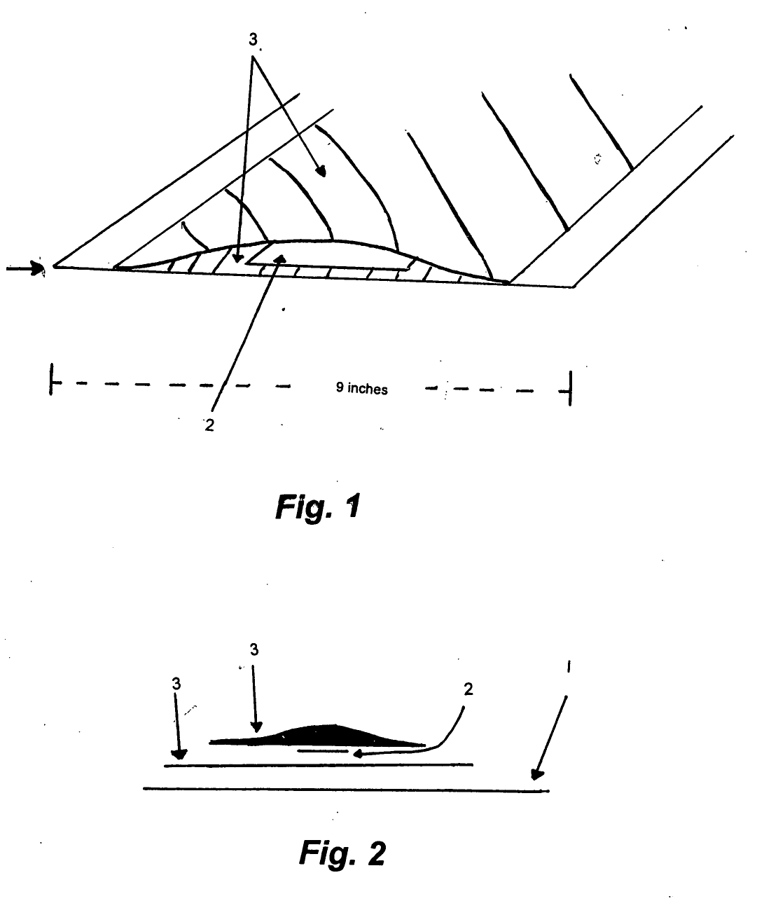

FIG. 1 is a perspective view of a composite structure (article) comprising a reinforcing material embedded in an adhesive material and which is coated onto a release liner. FIG. 1 shows a release liner (1), and a reinforcing material (2) embedded within adhesive layers (3).

FIG. 2 shows an exploded cross-section profile of the composite structure shown in FIG. 1, where (1) is the release liner, (2) is the reinforcing material and (3) are adhesive layers.

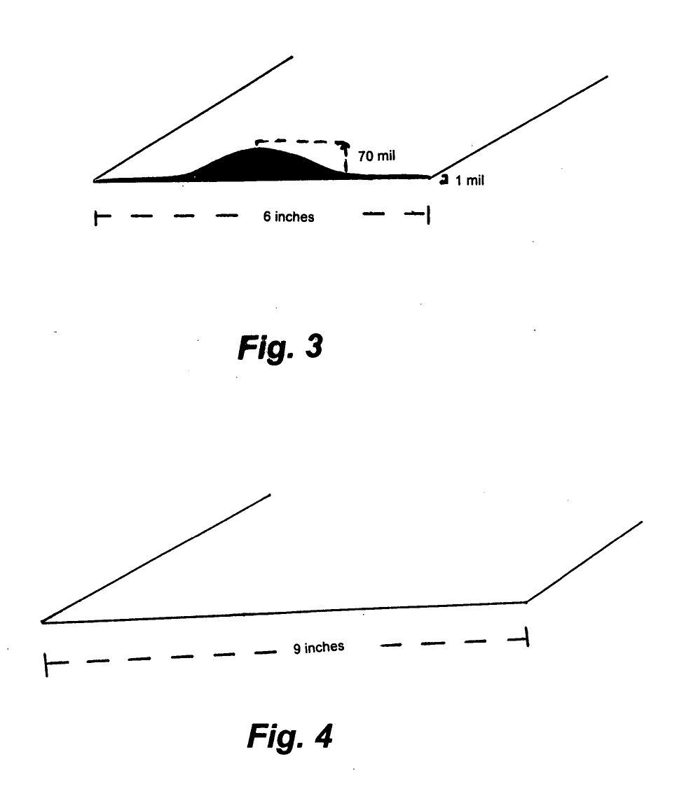

FIG. 3 shows an enlarged view from the application side of the composite, i.e., the side to be applied against the joint of adjacent wall board, of the first adhesive layer of FIG. 1. In the embodiment shown, the adhesive has a contour or profile such that the middle of the composite is substantially thicker than the outer edges.

FIG. 4 shows an enlarged view of the release liner of FIG. 1 from the outside side of the composite, i.e., the side of the composite against which heat is to be applied through the release liner.

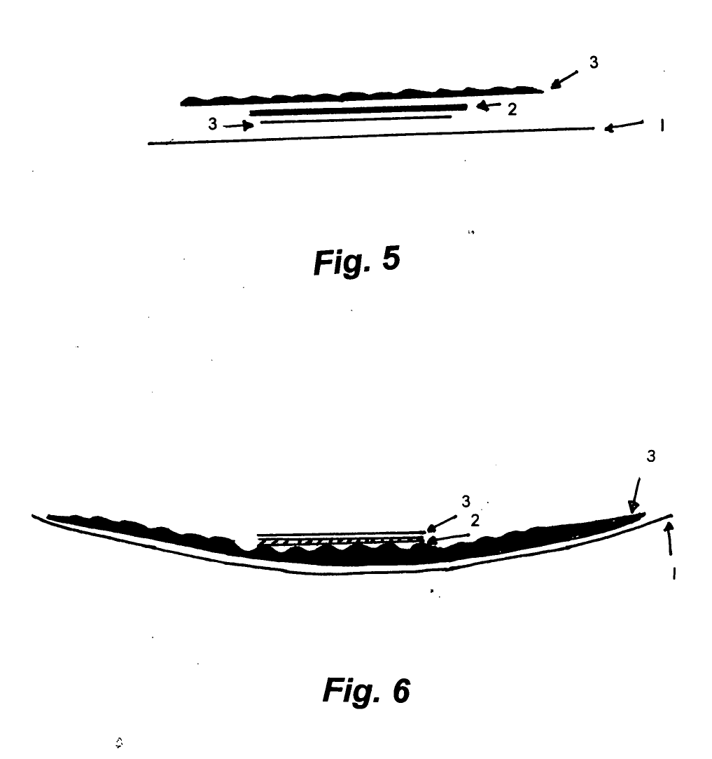

FIG. 5 shows an exploded cross-sectional view of an additional embodiment of the composite article of the invention. The profile of adhesive present on the back side of the reinforcing material exhibits a series of peaks and valleys.

FIG. 6 shows a cross-sectional view of yet another embodiment of the composite article of the invention. The profile of adhesive present on the front side of the reinforcing material exhibits a series of peaks and valleys.

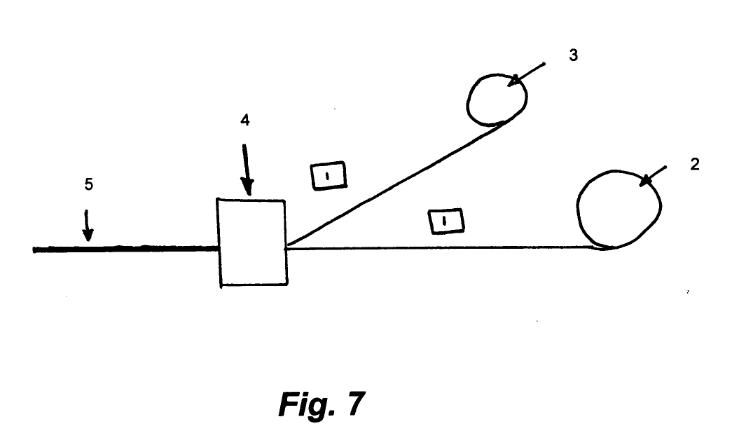

FIG. 7 is a diagram illustrating a method of making the composite structure of the invention.

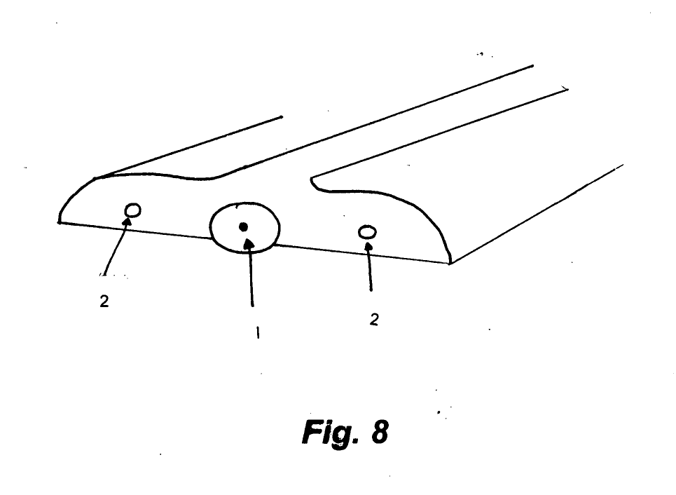

FIGS. 8 and 9 are cross-sectional views of a heating apparatus that can be used to apply the articles of the invention to wall board.

While the Figures show substantially straight boundary edges, it will be understood that the edges may, desirable, be irregularly shaped.

A tool such as an iron, that is heated, may advantageously be used to transfer the composite onto the wall by heating the composite and pressing it to the wall. When the liner has cooled sufficiently, preferably 2-5 minutes, the release liner is taken off revealing the product, which has covered the joint and left a smooth, level, paintable surface.

The heating tool may, alternatively, be a source of near infra-red, radio frequency or ultrasonic energy, for the purpose of heating.

Conventional household clothes iron may conveniently be used to apply the composite to the wall. It will, however, be appreciated that specially designed irons such as for example an iron modified with a free spinning bar that acts as a “rolling pin” to provide continuous and equal pressure on the product, such as is shown diagrammatically in FIGS. 8 and 9, may advantageously be used to apply the construct of the invention to the wallboard, and is a preferred method of application of the composite of the invention to the wall board and would facilitate application of the system of the invention when done by building contractors on a large scale basis. The diagrams shown in FIGS. 8 and 9 show a roller pin-like structure (1) that freely rolls to aid in spreading the heated adhesive. While in the embodiments shown, the roller is heated by conduction of heat provided from heating elements (2) located on either side of the roller, it will be appreciated that the roller itself could, alternatively, be heated directly. In one preferred embodiment, the rolling pin structure (1) is raised slightly above the heated platforms (3) located on both sides of the rolling pin.

The composites of the invention can be manufactured as show in FIG. 7. The composites of the invention are typically prepared by casting the adhesive onto the release liner and then drying or cooling the adhesive to form a tacky film.

The adhesive formulations may be pre-applied to the sides of the reinforcing material in a continuous or discontinuous, e.g., as evenly spaced beads or dots, manner depending on surface area and coating weight desired. Particular patterns may be used to optimize substrate/adhesive contact. Depending on the adhesive, the bead size, thickness, distance apart and pattern will vary. The adhesive may be pre-applied to the substrate by any method known in the art, and include, without limitation roll coating, painting, dry-brushing, dip coating spraying, slot-coating, swirl spraying, printing (e.g., ink jet printing), flexographic, extrusion, atomized spraying, gravure (pattern wheel transfer) electrostatic, vapor deposition, fiberization and/or screen printing. The method of pre-application to the substrate is not critical to the practice of the invention.

The films can be manufactured with a heat resistant release liner made from silicone-coated paper, polysiloxanes, polyolefins, or other low surface energy polymers that forms a protective removable coating over the adhesive. Other materials that can be used as a backing material include, with or without modification, metal foils, metalized polyfoils, composite foils or films containing poytetrafluoroethylene (TEFLON®)-type materials or equivalents thereof, polyether block amide copolymers, polyurethanes, polyvinylidene chloride, nylon, silicone elastomers, rubber-based poylisobutylene styrene, styrene-butadiene and styrene-isoprene copolymers, polyethylene, polyester, and other such materials used in the art of transdermal drug delivery. Particularly preferred are thermoplastic polymers such as polyolefins, for example polyethylene and polypropylene, and polyesters such as polyethyleneterephthalate.

The composites of the invention may be manufactured using hot melt adhesives, waterborne adhesives, solvent borne adhesives, moisture curable adhesives, acrylics, silicones, ultraviolet curable adhesives, blocked urethane systems, epoxy based adhesives, or adhesives comprising an encapsulated cureative. Thermoplastic and hot melt adhesives are particularly useful when formulated for pre-application and subsequent later reactivation. It will be apparent that a thermoplastic adhesive present on a substrate may be applied to a substrate in the form of a waterborne emulsion or solution.

It is to be understood that “hot melt adhesive” is used herein to mean thermoplastic substances which are composed of a thermoplastic polymeric material and a diluent system. The hot melt adhesive may be generally defined as 100 percent non-volatile thermoplastic substances which exist in a solid form at room temperature and which become sufficiently fluid or tacky at elevated temperatures to be employed as adhesives.

The term “hot melt pressure-sensitive adhesive” or “hot melt pressure-sensitive adhesive composition” as used hereinafter means an adhesive or adhesive composition which, upon production of adhesive goods such as adhesive tapes and adhesive sheets by applying an adhesive or adhesive composition to a base material such as paper, cloth or plastic film, is capable of forming a layer of the pressure-sensitive adhesive or pressure-sensitive adhesive composition on the base material by applying it to the base material as a hot-melt.

The term “pressure-sensitive adhesive” is used herein to refer to a viscoelastic material which adheres instantaneously to most substrates with the application of at least slight pressure and remains permanently tacky.

Typically hot melt adhesives useful in the practice of the invention will comprise an adhesive polymer, a tackifier, and optionally a wax. Any base polymer suitable for use in formulating hot melt adhesives, as are well known to those skilled in the art may be used in the practice of the invention. Such polymers include amorphous polyolefins, ethylene-containing polymers and rubbery block copolymers, as well as blends thereof. In a preferred embodiment, the adhesive comprises at least one ethylene copolymer, and may comprise a blend of two or more polymers. The term ethylene copolymer, as used herein, refers to homopolymers, copolymers and terpolymers of ethylene. Examples of ethylene copolymers include copolymers with one or more polar monomers which can copolymerize with ethylene, such as vinyl acetate or other vinyl esters of monocarboxylic acids, or acrylic or methacrylic acid or their esters with methanol, ethanol or other alcohols. Included are ethylene vinyl acetate, ethylene methyl acrylate, ethylene ethyl acrylate, ethylene n-butyl acrylate, ethylene acrylic acid, ethylene methacrylate and mixtures and blends thereof. Other examples include but are not limited to recycled polyethylene terphthalate and polyethylene, ethylene/α-olefin interpolymers, poly-(butene-1-co-ethylene), atactic polypropylene, low density polyethylene, homogenous linear ethylene/α-olefin copolymers, lower melt index n-butyl acrylate copolymers, ethylene vinyl ester copolymers). Random and block copolymers, as well as blends thereof may be used in the practice of the invention.

The adhesives may also comprise an energy absorbing ingredient, such as carbon black or organic dyes that absorb near infra-red energy, or a radio frequency absorbing ingredient that facilitates softening/melting (activation) of the adhesive.

In addition to conventional adhesives, the composites of the invention may be designed for “performance on demand,” being storage stable and non-reactive until activated or stimulated by some trigger or overt action, i.e., the composition's desired property is latent or dormant until activated for use. For example, the film can have a structured morphology, which is altered or changes upon application of a suitable impulse or trigger. Alteration in morphology leads to a change in property of the composition.

The heat activatable film may comprise a composition having a first morphology and corresponding first property of interest, wherein the first morphology and first property are altered by exposure to an amount of thermal energy effective to cause such alteration. Exposure to such effective amount of thermal energy causes a change in morphology and property. Thus, exposure to thermal energy, such a heat, leads to a second morphology and corresponding desired second property of interest. For example, the first property of interest may be lack of tack or adhesiveness and the second property may be tackiness or adhesiveness.

The joint systems formed in accordance with the invention are capable of being finally finished in a significantly shorter period of time than is required for those made with prior known methods. The method of the invention allows the formation of drywall joint systems of high quality in significantly shorter periods of time than were necessary with the prior known method thus enabling those engaged in the field of simulated monolithic wall construction to achieve substantial economies.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

1. An article comprising a reinforcing material having a front side and a back side and a predetermined length, width and thickness, a first adhesive present on at least a portion of said front side, a second adhesive present on at least a portion of said back side, and a heat resistant release liner having a front side and a back side and a predetermined length, width and thickness, said first adhesive being located between said front side of said reinforcing material and said back side of said release liner, and wherein at least one of said first or said second adhesive extends beyond at least the width of the reinforcing material.

2. The article of claim 1 wherein at least one of said first adhesive or said second adhesive is a thermoplastic adhesive.

3. The article of claim 1 wherein said second adhesive is contained within the boundaries of the reinforcing material, and said first adhesive extends beyond at least the width of the reinforcing material.

4. The article of claim 1 wherein said first adhesive is contained within the boundaries of the release liner.

5. The article of claim 3 wherein said first adhesive layer and said second adhesive layer extend beyond at least the width of the reinforcing material.

6. The article of claim 3 wherein said first and second adhesive layers are both hot melt adhesives.

7. The article of claim 6 wherein said second adhesive is a pressure sensitive adhesive.

8. The article of claim 7 wherein said second adhesive is a UV curable pressure sensitive hot melt adhesive.

9. The article of claim 3 wherein said first adhesive is a hot melt adhesive and said second adhesive is a pressure sensitive microsphere adhesive.

10. The article of claim 1 wherein the reinforcing material is a paper tape.

11. The article of claim 1 wherein the reinforcing material is a perforated tape.

12. An article comprising a reinforcing material having a front side and a back side and a predetermined length, width and thickness, at least a first adhesive layer present on at least a portion of said front side or said back side, and a heat resistant release liner having a front side and a back side and a predetermined length, width and thickness, said front side of said reinforcing material facing said back side of said release liner, and wherein at least said first adhesive layer extends beyond at least the width of the reinforcing material.

13. The adhesive of claim 12 further comprising a second adhesive, wherein said first adhesive layer is present on said first side of said reinforcing material and said second layer is located between said reinforcing material and said release liner.

14. The article of claim 13 wherein at least one of said first adhesive or said second adhesive is a thermoplastic adhesive.

15. The article of claim 13 wherein one of said first or second adhesive is contained within the boundaries of the reinforcing material, and the other of said first or second adhesive extends beyond at least the width of the reinforcing material.

16. The article of claim 15 wherein said first adhesive layer and said second adhesive layer extend beyond at least the width of the reinforcing material.

17. The article of claim 15 wherein said first and second adhesive layers are both hot melt adhesives.

18. The article of claim 17 wherein said second adhesive is a pressure sensitive adhesive.

19. A method of concealing a dry wall joint comprising positioning the article of claim 1 or 12 over a formed joint, said article positioned so the back side of the reinforcing material faces the joint surface, applying pressure and sufficient heat to said front side of the release liner to cause at least said first adhesive to flow, bond to the dry wall and conceal the joint.

20. The method of claim 19 wherein said article bonds to the drywall and conceals the joint to at least a level 3 equivalent finish.

21. A simulated monolithic wall prepared by the process comprising
erecting wall board panels in edge abutting relationship whereby a joint is formed there between,
covering the joint by positioning the article of claim 1 or 12 over a formed joint, said article positioned so the back side of the reinforcing material faces the joint surface,
applying pressure and sufficient heat to said front side of the release liner to cause at least said first adhesive to flow, bond to the dry wall and conceal the joint, and
applying a wall covering finish.

22. The method of claim 21 wherein said article bonds to the drywall and conceals the joint to at least a level 3 equivalent finish.

23. The method of claim 22 wherein the wall covering is paint.

24. An article comprising a heat resistant release liner having positioned thereon a substantially circular deposit of a thermoplastic adhesive, said deposit having a mean diameter of at least about an inch, and which deposit is substantially thicker in the middle than at its circumference, where the deposit is tapered to a very thin layer.
